(19) United States
(12) Patent Application Publication
(10) Pub. No.: US 2002/0157294 A1
(43) Pub. Date: Oct. 31, 2002

(54) Magnetic decorative appliques

(76) Inventor: Heather Stanley, Saugus, CA (US)

Correspondence Address: Roger A. Marrs, Suite 1120, 15233 Ventura Blvd., Sherman Oaks, CA, 91403, US

(21) Appl. No.: 09/954,897

(22) Filed: Sep. 19, 2001

Related U.S. Application Data
(60) Provisional application No. 60/286,653, filed on Apr. 27, 2001.

(51) Int. Cl. G09F 7/04

(52) U.S. Cl. 40/600

(57) ABSTRACT

Multiple magnetic decorative appliques are provided with each having a sheet of think and flexible magnetic material wherein one side of the sheet exposes magnetic forces for attraction to a metallic door, such as a garage door. The obverse side of each magnetic sheet is provided with a smooth layer on which painted or printed decorative matter is placed. The decorative matter may take the form of alpha/numeric indicia, graphic representations or other ornamental and decorative figures. The plurality of magnetic decorative appliques can be carried in a plastic bag with a cardboard header identifying the product and including instructions. A brush, paints or the like can be placed in the bag and the user can create his or her own decorations on blank applique sheets.

### BACKGROUND OF THE INVENTION

1. Field of the Invention

The present invention relates to the field of decorative displays, and more particularly to a novel magnetic display that may be placed on the front face of a metal door and wherein the various decorative appliques can be arranged at the discretion of the user so as to be placed in a variety of ornamental selections.

2. Brief Description of the Prior Art

In the past, it has been conventional practice to employ a single display device, such as a button, disk or the like, onto magnetic receptive metal cabinets such as refrigerators or the like and such displays include single printed or painted magnets that are not used in combination with other displays to produce an overall effect. Therein lies the problem in that a plurality of different display appliques are not being utilized to produce an overall display when arranged in separate locations with respect to each other. Also, problems and difficulties have been encountered when employing conventional magnetic displays since the magnet itself is relatively thick, heavy and oftentimes interferes with the ornamental display of any indicia or graphic representations or decorative subject matter appearing on the magnet. Such prior magnets are considered to be of a small size and are not suitable for multiple display in a coordinated fashion. Also, the display on conventional magnetic buttons does not provide for protection of the graphics such as by protective coating or the like.

A further problem with conventional magnets is that they are not flexible and are not adapted for accommodating curved or arcuate surfaces to which they are attached.

Therefore, a long-standing need has existed to provide a novel decorative display which coordinates a plurality of flexible magnetic appliques and wherein each applique includes graphic representations that are coordinated and arranged in an overall pattern.

### SUMMARY OF THE INVENTION

Accordingly, the above problems and difficulties are avoided by the present invention which provides a novel magnetic decorative applique having a sheet of thin and flexible magnetic material wherein one side of the sheet exposes magnetic forces for attraction to a metallic door such as a garage door. The obverse side of the magnetic sheet is provided with a smooth layer on which painted or printed decorative matter is placed. The decorative matter may take the form of alpha/numeric indicia, graphic representations or other ornamental and decorative figures.

In one form of the invention, the plurality of magnetic decorative appliques can be carried in a plastic bag with a cardboard header identifying the product and including instructions. Also, a brush, paints or the like can be placed in the bag and the user can create his or her own decorations on blank applique sheets.

In any event, the plurality of decorative appliques can then be arranged in a selected pattern on the metal door and the magnetic attraction of each of the respect-appliques will hold each applique onto the door. Rearrangement of the appliques can be made by the user in order to create different overall decorative scenes or patterns.

Therefore, it is among the primary objects of the invention to provide a novel magnetic decorative applique which is flexible and thin so that it may be releasably placed in a desired position on a metal door such as a garage door.

Another object of the present invention is to provide a decorative applique on a magnetic sheet wherein a protective coating is placed over the graphic representation, indicia or alpha/numeric representations in order to protect the decoration from environmental conditions.

Still another object of the invention is to provide a plurality of magnetic appliques that can be arranged in a selective and desired pattern or arrangement on a garage door in order to provide an overall graphic effect.

Still another object resides in providing a single magnetic decorative applique having a large surface area for carrying ornamental printing, painting or the like and which is covered with a protective coating to prevent fatigue and degradation due to environmental conditions.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a graphic illustration of a plurality of appliques and a bag for holding the appliques preparatory for installation on a garage door in accordance with the present invention;

FIG. 2 is a front elevational view of a magnetic garage door having the plurality of appliques shown in FIG. 1 arranged in a selected pattern or arrangement on the face of the door;

FIG. 3 is a front elevational view of a different metal door than the garage door shown in FIG. 2 with an arrangement of decorative applique placed thereon;

FIG. 4 is an enlarged fragmentary sectional view of the magnetic decorative applique and metal door illustrated in FIG. 1 as taken in the direction of arrows 4-4 thereof;

FIG. 5 is a diagrammatic perspective view illustrating a kit for preparing ornamental displays on magnetic sheets in accordance with the present invention that forms a kit; and

FIG. 6 is indicia showing different greetings, salutations and phrases that may be employed on various appliques incorporated in the present invention.

### DESCRIPTION OF THE PREFERRED EMBODIMENT

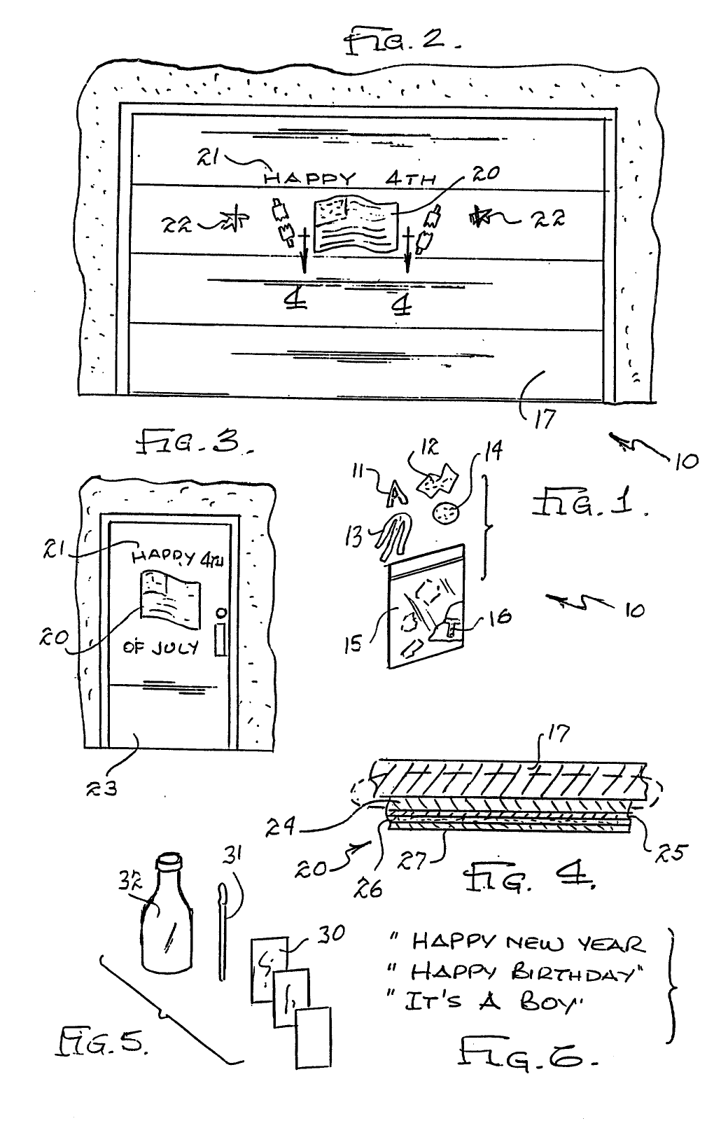

Referring to FIG. 1, the novel decorative magnetic appliques are illustrated in the general direction of arrow 10 which includes a plurality of separate and individual appliques such as identified by numerals 11, 12, 13 and 14. The appliques may be carried in a bag 15 and a typical applique in the bag is identified by numeral 16. It is to be understood that each of the respective decorative appliques is composed of a magnetic sheet having a front or obverse face on which the decorative is carried. The decoration may take the form of alpha/numeric indicia, graphic representations or other ornamental phrases or the like.

Referring now in detail to FIG. 2, it can be seen that the plurality of appliques is illustrated in the general direction of arrow 10 and they are affixed to the front of a metallic garage door 17. For purposes of explanation, a different set of appliques is illustrated wherein a flag is represented by numeral 20 and the phrase “Happy 4th” is indicated by numeral 21. Various elements, such as stars 22, can also be included. It is to be understood that each of the respective appliques is separate from one another and that the arrangement or pattern of the attachment is at the selection and discretion of the user.

Referring now in detail to FIG. 3, an alternate door is illustrated by numeral 23 which is still metal and, as previously described, the arrangement of decorative applique may be of any pattern selected by the user.

FIG. 4 is an enlarged fragmentary cross-sectional view of applique 20 and it can be seen that the applique includes a flexible sheet of magnetic material 24 on which a graphic representation is carried and represented by numeral 25. Paint or the like is represented by numeral 26 and may be incorporated directly into the face of sheet 24 or may be included with the decorative sheet 25. In any event, a protective coating or layer 27 is included which protects the graphics from environmental conditions since the appliques are intended for outside use.

Referring now in detail to FIG. 5, it is to be understood that the present invention may be supplied in the form of a kit wherein a multiplicity of blank magnetic 30 is provided and the user may employ a brush 31 and paints in a container 32 so as to decorate the front surface of each of the flexible magnetic sheets 30. The shape of the magnetic sheets 30 may take the form of any graphic representation and the choice of colors, lines and denotations is at the selection of the user. For example, a variety of indicia for phrases and sentences can be used and a sample arrangement is illustrated in FIG. 6. The user is not limited to the “Happy New Year, Happy Birthday, or It's a Boy” slogans shown in FIG. 6 but these are representative of the variety.

Large magnetic decorative painted appliques are used on metal doors, particularly garage doors, or doors of mobile homes, motor homes or the like. In one form, the magnetic sheeting is of a 0.020 gauge and the sheeting is cut into large shapes and letters so as to be used in a useful scene or individually. Using larger scale pictures and lettering to decorate large metal surfaces is preferred. The appliques may be sold in a kit and each kit can have anywhere from one to 50 separate pieces or separate appliques including each individual letter of the alphabet.

The appliques are easy to put on and take off because of the magnetic attraction and no electricity is required. Each of the appliques is very light in weight and weather resistant. Furthermore, each packaged kit may include instructions and have a diagram showing where to place each piece or applique in order to display a particular scene properly.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

What is claimed is:

1. A decorative array of magnetic appliques comprising:
a plurality of sheets of magnetic material with each sheet having a first surface exposing magnetic forces for attraction to a metallic door and a second surface having a smooth finish for receiving and displaying decorative matter;
said decorative matter constituting alpha/numeric, graphic representations or decorative figures; and
said plurality of sheets being a critical arrangement on said door to provide a combined related pattern of said decorative matter on each of said sheets.

2. The decorative array defined in claim 1 wherein:
said critical arrangement provides an over-all decorative identification of a festive occasion.

3. The decorative array defined in claim 2 wherein:
each second surface of each sheet carries decorative representations and an overlay protective coating separating said decorative representation from environmental conditions.

4. The decorative array defined in claim 3 wherein:
said critical arrangement is composed of said plurality of sheets wherein each sheet is in fixed, spaced-apart relationship with respect to each other.

5. The decorative array defined in claim 4 wherein:
each sheet is flexible so as to mate with a curved surface of said door.

6. The decorative array defined in claim 5 including:
a bag storing said plurality of sheets of related decorative representations preparatory for placement on said door.

7. The decorative array defined in claim 6 including:
a brush, a set of paints and printed instructions stored in said bag wherein said bag constitutes a kit.

8. In a plurality of magnetic sheets for use in providing a decorative array or pattern on a metallic door, the improvement which comprises:
each sheet in said plurality having a front side and a back side;
decorative subject matter carried on said front side of each sheet of said plurality and said back side exposed for emitting a magnetic flux field therefrom;
each of said sheets being flexible; and
said decorative subject matter being arranged on each of said sheets so as to coordinate and compliment decorative subject matter on all of said sheets when forming said array or pattern on said door.
